(19) United States
(12) Patent Application Publication
(10) Pub. No.: US 2025/0220110 A1
(43) Pub. Date: Jul. 3, 2025

(54) LOCATION-BASED PHONE NOTIFICATION SILENCER

(71) Applicant: DISH Network Technologies India Private Limited, Bangalore (IN)

(72) Inventors: Sendhil Kumar KB, Vaniyambadi (IN); AVS V Sreevastav, Kurnool (IN); Arun Pulasseri Kalam, Varthur (IN); Anandaraj P, Araikulam (IN)

(21) Appl. No.: 18/397,982

(22) Filed: Dec. 27, 2023

(51) Int. Cl. H04M 1/72457; G01S 19/42

(52) U.S. Cl. CPC H04M 1/72457; G01S 19/42

(57) ABSTRACT

A mobile device having a transceiver that wirelessly receive a short-range signal, a position sensor that wirelessly receive a navigation signal, and memory that stores application settings that comprise silent area information that identifies a geographic location where a silent area is established and quiet zone information that identifies a geographic location where a quiet zone is established. The mobile device has control circuitry that processes the quiet zone information and the navigation signal to determine whether or not the mobile device is in the quiet zone. The control circuitry processes the quiet zone information and the navigation signal when the position sensor receives the navigation signal. The control circuitry processes the silent area information and the short-range signal to determine whether or not the mobile device is in the silent area.

### BACKGROUND

Mobile phones, also known as cell phones and smartphones, are lightweight portability electronic devices that can provide a person various forms of wireless communication and functionality while the person is away from a fixed location, such as their home or office.

Wireless communication can enable the mobile phones to initiate and receive telephone calls. Additional advantages of wireless communication provided by mobile phones can include email messaging, text messaging, receiving multimedia content, and providing access to Internet services. Some mobile phones are equipped with cameras.

### DRAWINGS

The accompanying drawings, which are incorporated in and form a part of this specification, illustrate examples of the disclosure and, together with the description, explain principles of the examples. In the drawings, like reference symbols and numerals indicate the same or similar components.

FIG. 1 illustrates an example of a mobile device.

FIG. 2 is a flowchart that illustrates an example of silencer processing by the mobile device.

FIG. 3 illustrates an example of the mobile device traversing through various locations.

Like elements in the various figures are denoted by like reference numerals for consistency.

### DETAILED DESCRIPTION

Exemplary embodiments are described in detail with reference to the accompanying drawings.

Mobile phones may emit various sounds while in operation. These sounds may include ringtone sounds for incoming telephone calls, notification sounds for incoming email messages and incoming text messages, keypad sounds when typing on touchscreens of the mobile phones, camera shutter sounds when taking pictures with the mobile phones, and multimedia sounds when playing videos, music and/or games on the mobile phones.

In some instances, sound emissions from mobile phones in quiet environments can become problematic. For example, quiet environments can refer to noise sensitive areas where sound emissions from mobile phones are considered to be noise disturbances that are disruptive, intrusive, and generally disturbing others. Some examples of these noise sensitive areas may include religious spaces, libraries, study halls, quiet rooms, restaurants, certain public buildings, certain residential neighborhoods, and healthcare facilities such as hospitals.

A “Do Not Disturb” mode can instruct the mobile phone to silence sound emissions from mobile phone. Generally, mobile phones settings can be switched to the “Do Not Disturb” mode when a person enters a quiet environment. However, to silence the sound emissions from the mobile phone by placing the mobile phone into the “Do Not Disturb” mode, some sort of manual adjustment made to the settings of the mobile phone is typically required before the person enters the quiet environment is required. To resume the sound emissions from the mobile phone after the person departs the quiet environment, yet another manual adjustment made to the settings of the mobile phone is typically required to deactivate the “Do Not Disturb” mode.

As a consequence, there is a need in the art to configure a mobile phone to automatically switch to a silent mode upon entering into a quiet environment and to automatically switch from the silent mode upon departing from the quiet environment.

The following describes technical solutions in this application with reference to the accompanying drawings. For the sake of clarity and conciseness, matters related to the present embodiments that are well known in the art have not been described. Unless otherwise indicated, like parts and method steps are referred to with like reference numerals.

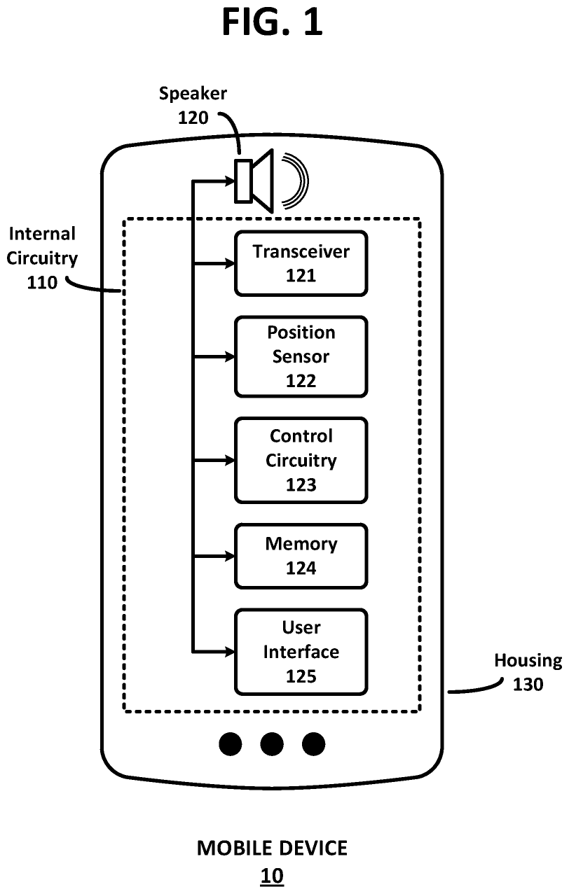

FIG. 1 illustrates a mobile device 10. The mobile device 10 may communicate wirelessly with a telecommunications network. The mobile device 10 may be a smartphone, a tablet, a wearable device, a smartwatch, a fitness tracker, and/or any other portable electronic device that can be carried by or worn on a person. Components of the mobile device 10 may include internal circuitry 110, a speaker 120 and housing 130. Those skilled in the art will appreciate that there may be additional components of the mobile device 10 that are not shown in FIG. 1.

Internal circuitry 110 may be built into the mobile device 10. Components of the internal circuitry 110 may include a transceiver 121, a position sensor 122, control circuitry 123, memory 124, and a user interface 125. As illustrated in FIG. 1, the speaker 120, the transceiver 121, the position sensor 122, the control circuitry 123, and the memory 124 are encased in the housing 130.

The transceiver 121 is electronic circuitry that may facilitate wireless communication between the mobile device 10 and a telecommunications network. The telecommunications network may include a public or private data network. The public or private data network may comprise or be part of a radio access network (RAN), a wireless fidelity (wi-fi) network, a wired or wireless information network, a public switched telephone network, a satellite network, a local area network (LAN), a wide area network (WAN), and/or the Internet. As will be explained in detail, the transceiver 121 may wirelessly connect the mobile device 10 to the telecommunications network to facilitate wireless communication between the telecommunications network and the mobile device 10.

The mobile device 10 is equipped with the position sensor 122. As will be explained in detail, the position sensor 122 is electronic circuitry that may wirelessly receive a navigation signal that allows the control circuitry 123 to determine the precise location of the mobile device 10. The navigation signal may include, but is not limited to, a wi-fi signal, a Global Positioning System (GPS) signal, and a signal from a cell tower.

The control circuitry 123 may control the overall operations of the television 11. The control circuitry 123 may be implemented as any suitable processing circuitry including, but not limited to at least one of a microcontroller, a microprocessor, a single processor, and a multiprocessor. The control circuitry 123 may include at least one of a central processing unit (CPU), a graphic processing unit (GPU), a microprocessor, an application specific integrated circuit (ASIC), field programmable gate arrays (FPGA), or the like, and may have a plurality of cores.

Memory 124 may be a non-transitory processor readable or computer readable storage medium. Memory 124 may store filters, rules, data, or a combination thereof. Memory 124 may comprise read-only memory (“ROM”), random access memory (“RAM”), other non-transitory computer-readable media, or a combination thereof. In some examples, memory 124 may store firmware. Memory 124 may store software for the mobile device 10. The software for the mobile device 10 may include program code. The program code may include program instructions that are readable and executable by the control circuitry 123, also referred to as machine-readable instructions. Memory 124 may be any electronic, magnetic, optical, or other physical storage device that stores executable instructions and/or data.

The speaker 120 is a transducer that may receive electrical signals from the control circuitry 123 and convert the electrical signals into audible sounds. The audible sounds are sounds that could be heard by the human ear. The electrical signals the control circuitry 123 may be in analog form and/or digital form. The speaker 120 may receive, from the control circuitry 123, audio information that controls the speaker 120 in a manner that causes the speaker 120 to adjust the audible sounds that the speaker 120 emit. The speaker 120 may comprise one or more speakers.

As illustrated in FIG. 1, the transceiver 121, the position sensor 122, the control circuitry 123, the memory 124, the speaker 120, and the user interface 125 are interconnected electronically. The user interface 125 may include electronic circuitry and a touchscreen. The control circuitry 123 may configure the touchscreen as a graphical user interface (GUI).

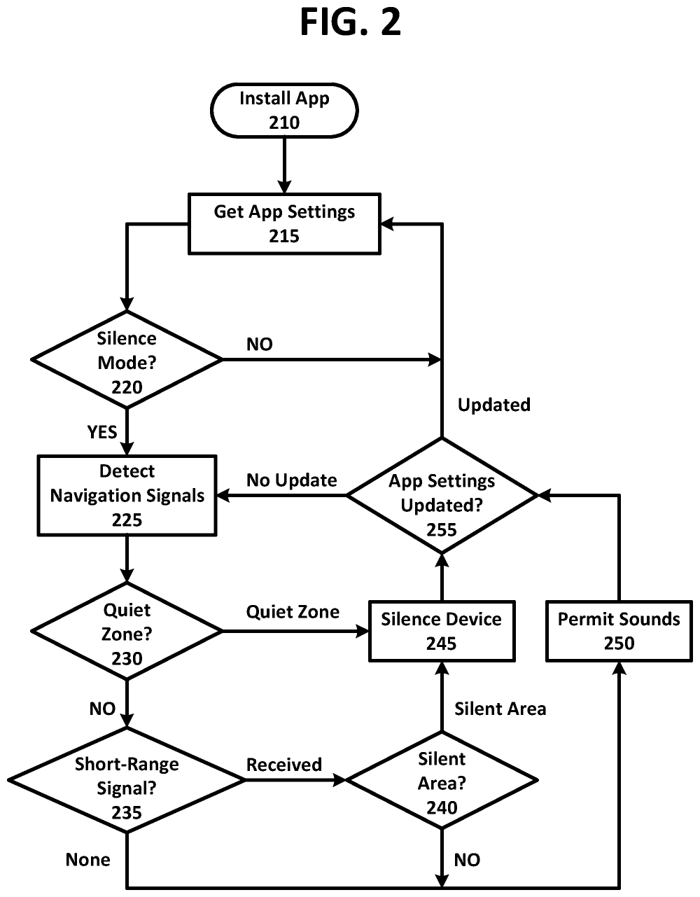

FIG. 2 is a flowchart that illustrates an example of silencer processing by the mobile device 10. A silencer app is a software that is operable by the mobile device 10. As will be explained in detail, the silencer app may be machine-readable instructions for the execution of the silencer processing in FIG. 2 by the control circuitry 123.

The silencer processing in FIG. 2 begins at block 210 when the control circuitry 123 may control the transceiver 121 to wirelessly receive the silencer app from a digital distribution platform. Examples of a digital distribution platform may include the Apple App Store®, the Google Play Store®, and/or any other digital distribution platform. When the mobile device 10 receives the silencer app from the digital distribution platform, the control circuitry 123 may install the silencer app by controlling the memory 124 to store the silencer app into the memory 124. In block 210, the control circuitry 123 may control the memory 124 to store, into memory 124, default settings for the silencer app. The default settings may permit the mobile device 10 to emit audible sounds such as ringtones, notifications, alarms, and alerts.

The default settings may include quiet zone information and silent area information. The quiet zone information may comprise a listing of quiet zones and the silent area may comprise a listing of silent areas. A quiet zone may refer to a space, an area, and/or a geographic location where noise disruptions made by sounds emitted from an electronic device are to be minimized or eliminated. The quiet zone information may identify geographic locations where quiet zones are established. A silent area may refer to a space, an area, and/or a geographic location where noise disruptions made by sounds emitted from an electronic device are to be minimized or eliminated. The silent area information may identify geographic locations where silent areas are established. The electronic device may be the mobile device 10. A silent area and a quiet zone may be established at a same geographic location and share the geographic location. Conversely, a silent area and a quiet zone may be established at different geographic locations. Typically, a silent area is smaller than a quiet zone.

The default settings may include Service Set Identifiers (SSID) that uniquely identify short-range signals. As will be explained in detail, the transceiver 121 may wirelessly the short-range signals at the silent areas.

Also in block 210, the control circuitry 123 may control the user interface 125 to display an icon of the silencer app on the touchscreen of the user interface 125. The control circuitry 123 may control the user interface 125 to enable receipt by the GUI of any silencer app setting for the silencer app. The control circuitry 123 may advance the silencer processing in FIG. 2 from block 210 to block 215.

In block 215, the control circuitry 123 may obtain silencer app settings for the silencer app. The silencer app settings may include the default settings that the control circuitry 123 stores into memory 124 during the installation of the silencer app in block 210.

Adjustments and modifications to any of the default settings may occur when updates to the silencer app are downloaded to the mobile device 10 and stored into the memory 124.

A user of the mobile device 10 may be a person who operates the mobile device 10. When the GUI acquires the silencer app settings, entries for any of the silencer app settings made through the GUI manually by the user may supersede and replace any of the default settings that are stored in memory. For example, the control circuitry 123 may control the user interface 125 to display a map on the touchscreen of the user interface 125.

When controlling the user interface 125 to display the map on the touchscreen of the user interface 125, the control circuitry 123 may enable receipt by the GUI of the silencer app settings that specify a specific location or coordinate on the map where the mobile device 10 is to be silenced. For example, the silencer app settings may comprise the silent area information. The silencer app settings may comprise the quiet zone information. The silencer app settings received by the GUI may include an address where the mobile device 10 is to be silenced. The silent area information received by the GUI may comprise an SSID that uniquely identifies a short-range signal that is that may be receivable at a silent area where the mobile device 10 is to be silenced. The control circuitry 123 may control the memory 124 to store the silencer app settings into memory 124.

Memory 124 may store a contact list that includes a group of telephone numbers. The control circuitry 123 may control the user interface 125 to enable receipt by the GUI of any emergency telephone number and control memory 124 to store each emergency telephone number into memory 124. The control circuitry 123 may also control the user interface 125 to enable receipt by the GUI of a call frequency setting that quantifies the number of times the mobile device 10 may receive a telephone call from any legitimate telephone number during the time period that the mobile device 10 is in a silence mode. A legitimate telephone number may include an emergency telephone number. The legitimate telephone number may include a telephone number in the contact list. The control circuitry 123 may advance the silencer processing in FIG. 2 from block 215 to block 220.

Upon retrieving the silencer app settings, the control circuitry 123 may in block 220 process the silencer app settings to determine whether or not the silencer app settings indicate placement of the mobile device 10 into the silence mode by the silencer app. The control circuitry 123 may advance the silencer processing in FIG. 2 from block 220 to block 215 when the control circuitry 123 determines in block 220 that the silencer app settings indicate the placement of the mobile device 10 into a mode other than the silence mode. Alternatively, the control circuitry 123 may advance the silencer processing in FIG. 2 from block 220 to block 225 when the control circuitry 123 determines in block 220 that the silencer app settings indicate the placement of the mobile device 10 into the silence mode.

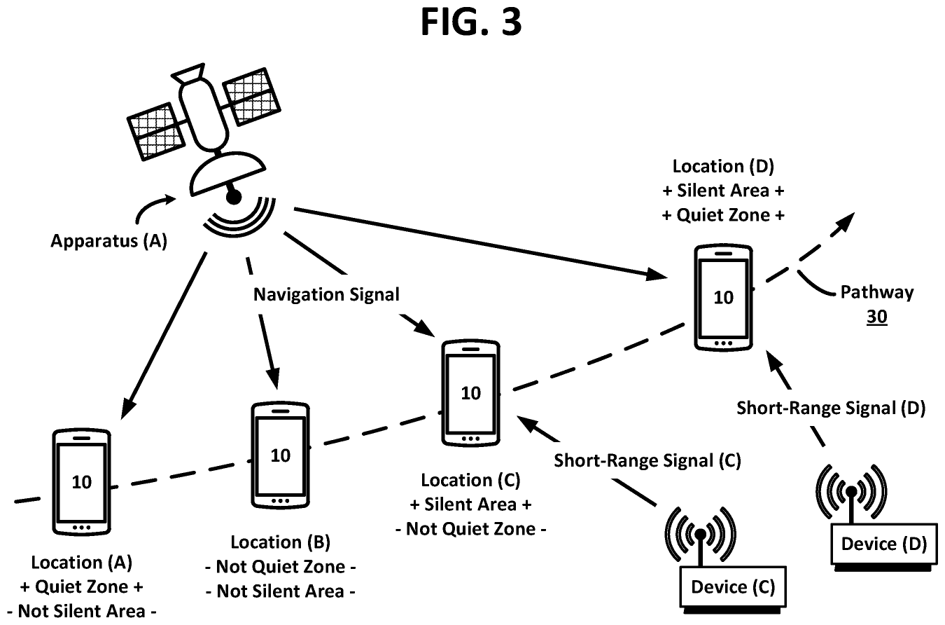

In block 225, the control circuitry 123 may control the position sensor 122 to wirelessly receive the navigation signal. The navigation signal may include, but is not limited to, a signal from a cell tower, a wi-fi signal, and a GPS signal. In the example of FIG. 3, apparatus (A) may emit the navigation signal. The control circuitry 123 may advance the silencer processing in FIG. 2 from block 225 to block 230.

In regard to block 230 and other blocks in FIG. 2, FIG. 3 illustrates an example of the mobile device 10 traversing through locations (A), (B), (C) and (D), which are various locations along pathway 30 in FIG. 3. As illustrated in FIG. 3, each of the locations (A), (B), (C) and (D) may be a geographical location that differs from a geographical location for any other of the locations (A), (B), (C) and (D).

Locations (A) and (D) may each be quiet zones whereas the locations (B) and (C) may each be areas other than a quiet zone. The electronic device may be the mobile device 10. At each of the locations (A), (B), (C) and (D) in the example of FIG. 3, the mobile device 10 may receive the navigation signal. In block 230, the control circuitry 123 may, when processing the navigation signal, detect whether or not the mobile device 10 is in a quiet zone.

In block 230, the control circuitry 123 may retrieve the silencer app settings from memory 124 and extract the quiet zone information from the silencer app settings. For example, when the position sensor 122 receives the navigation signal, the control circuitry 123 may obtain position information from the navigation signal. The position information may precisely identify the geographic position of the mobile device. The control circuitry 123 may compare the quiet zone information with the position information to determine whether or not the position information identifies one of the quiet zones that are listed in the quiet zone information. When the control circuitry 123 determines in block 230 that the position information identifies one of the quiet zones, the control circuitry 123 may advance the silencer processing in FIG. 2 from block 230 to block 245. In the example of FIG. 3, locations (A) and (D) may each be a quiet zone and the control circuitry 123 may advance the silencer from block 230 to block 245 when the mobile device 10 is in either location (A) or location (D).

Alternatively, when the control circuitry 123 determines in block 230 that the mobile device 10 is in a geographic location other than a quiet zone, the control circuitry 123 may advance the silencer processing in FIG. 2 from block 230 to block 235. Regarding this aspect, locations (B) and (C) in the example of FIG. 3 may be areas other than a quiet zone and the control circuitry 123 may advance the silencer from block 230 to block 235 when that the mobile device 10 is in either location (B) or location (C).

In block 235 of FIG. 2, the control circuitry 123 may determine whether or not the transceiver 121 has wirelessly received the short-range signal. The short-range signal may be a wi-fi signal, a Bluetooth signal, an ultra-wideband (UWB) signal, and/or any other wireless signal that may exchange information only over relatively short distances. In the example of FIG. 3, device (C) may emit short-range signal (C), and device (D) may emit short-range signal (D). The control circuitry 123 may control the transceiver 121 in a manner that permits the transceiver 121 to receive a short-range signal.

When the control circuitry 123 determines in block 235 that the transceiver 121 has not received any short-range signal, the control circuitry 123 may advance the silencer processing in FIG. 2 from block 235 to block 250. Alternatively, upon receipt of the short-range signal by the transceiver 121, the control circuitry 123 may advance the silencer processing in FIG. 2 from block 235 to block 240 when the control circuitry 123 determines in block 235 that the transceiver 121 has received a short-range signal.

In block 240, the control circuitry 123 may process the short-range signal to determine whether or not the short-range signal may include an identifier. For example, the control circuitry 123 in block 240 may retrieve the silencer app settings from memory 124 to obtain the silent area information from the silencer app settings. When the transceiver 121 receives the short-range signal, the control circuitry 123 may extract, from the short-range signal, an identifier that uniquely identifies the short-range signal. The control circuitry 123 may compare the silent area information with the identifier to determine whether or not the identifier is listed in the silent area information. The identifier may be an SSID that uniquely identifies the short-range signal. The identifier may identify an area as a “silent area.” When the control circuitry 123 determines in block 240 that the identifier is listed in the silent area information, the control circuitry 123 may advance the silencer processing in FIG. 2 from block 240 to block 245.

In the example of FIG. 3, locations (C) and (D) may each be a silent area and the control circuitry 123 may advance the silencer from block 240 to block 245 when the mobile device 10 is in either location (C) or location (D).

Alternatively, when the control circuitry 123 determines in block 240 that the mobile device 10 is in a geographic location other than a silent area, the control circuitry 123 may advance the silencer processing in FIG. 2 from block 240 to block 250. The control circuitry 123 may advance the silencer processing in FIG. 2 from block 240 to block 250 when the control circuitry 123 determines the absence of a silent area identifier in any the short-range signal that the mobile device 10 receives in block 235. Regarding this aspect, locations (A) and (B) in the example of FIG. 3 may be areas other than a silent area and the control circuitry 123 may advance the silencer from block 240 to block 250 when that the mobile device 10 is in either location (A) or location (B).

Alternatively, when the control circuitry 123 determines that the short-range signal identifies a silent area, the control circuitry 123 process the silencer app to advance the silencer processing in FIG. 2 from block 240 to block 245. In the example of FIG. 3, locations (C) and (D) may each be a silent area and the control circuitry 123 may advance the silencer from block 240 to block 245 when that the mobile device 10 is in either location (C) or location (D).

In block 245, the control circuitry 123 may control the speaker 120 to inhibit the speaker 120 from emitting the audible sounds. Sound settings for other executable apps and software stored in the memory 124 may instruct sound emissions from the speaker 120. Prior to preventing the audible sound emissions from the speaker 120 in block 245, the control circuitry 123 may control the memory 124 to store the sound settings for the other executable apps and software. When the mobile device 10 receives multiple or successive telephone calls from a same telephone number or a same legitimate telephone number during a time period in block 245, the control circuitry 123 may control the speaker 120 to permit the emission of the audible sounds from the speaker 120.

While in block 245, the control circuitry 123 permit the mobile device 10 to generate other notifications. Notifications may include, but are not limited to, tactile notifications that include vibration of the mobile device 10. Notifications may also include visual notifications composed of messages appearing on the touchscreen of user interface 125 and/or audio notifications emitted from an audio device when the audio device is in electronic communication with the mobile device 10. The audio device may include headphones or earphones.

Also while in block 245, the control circuitry 123 may permit the mobile device 10 to access the Internet, perform email and text messaging, and conduct other non-auditory functions of the mobile device 10. For example, when the mobile device 10 receives multiple or successive telephone calls from the same telephone number or the same legitimate telephone number during a time period in block 245, the control circuitry 123 may control the transceiver 121 to send a notification to the telephone number or legitimate telephone number when the number of successive telephone calls is at least equal to the call frequency setting.

Referring to the example of FIG. 3, the control circuitry 123 may control the speaker 120 to inhibit the emission of the audible sounds from the speaker 120 when the mobile device 10 is at location (A), to permit the emission of the audible sounds from the speaker 120 when the mobile device 10 is at location (B), inhibit the emission of the audible sounds from the speaker 120 when the mobile device 10 is at location (C), and inhibit the emission of the audible sounds from the speaker 120 when the mobile device 10 is at location (D). The control circuitry 123 may control the speaker 120 to permit the emission of the audible sounds from the speaker 120 in the example of FIG. 3 only when the mobile device 10 is geographically at locations having conditions for navigation signals and short-range signals that are similar to the navigation and short-range signals at location (B).

The control circuitry 123 may advance the silencer processing in FIG. 2 from block 240 to block 250. In block 250, the control circuitry 123 may control the speaker 120 to permit the emission of the audible sounds from the speaker 120. Specifically, silencer app may retrieve the sound settings from the memory 124 prior to automatically adjusting the sound settings in the mobile device 10 to permit audible sound emissions from the speaker 120. While in block 250, the control circuitry 123 permit the mobile device 10 to generate other notifications. These other notifications may include, but are not limited to, tactile notifications that include vibration of the mobile device 10. These other notifications may include visual notifications composed of messages appearing on the touchscreen of user interface 125. These other notifications may include audio notifications emitted from an audio device when the audio device is in electronic communication with the mobile device 10. The audio device may include headphones or earphones. Also while in block 250, the control circuitry 123 permit the mobile device 10 to access the Internet, perform email and text messaging, and conduct other non-auditory functions of the mobile device 10. The control circuitry 123 may advance the silencer processing in FIG. 2 from block 250 to block 255.

In block 255, the control circuitry 123 may determine whether or not any of the silencer app settings are updated. The user interface 125 may be operable during the entirety of the silencer processing in FIG. 2 and may receive inputs that update the silencer app settings. The control circuitry 123 may advance the processing in FIG. 2 from block 255 to block 225 when the control circuitry 123 determines the absence of any update to the silencer app settings. Alternatively, the control circuitry 123 may advance the processing in FIG. 2 from block 255 to block 215 when the control circuitry 123 determines the presence of an update to any of the silencer app settings.

Benefits of the silencer processing as illustrated in FIG. 2 and described herein may include an improved operability of the mobile device 10. Other benefits may include the automatic placement of the mobile device 10 into the silence mode when the mobile device 10 enters a quiet zone or a silent area. The silencer processing as illustrated in FIG. 2 and described herein may also improve mobility robustness and user experience.

In some examples, aspects of the technology, including computerized implementations of methods according to the technology, may be implemented as a system, method, apparatus, or article of manufacture using standard programming or engineering techniques to produce software, firmware, hardware, or any combination thereof to control a processor, also referred to as an electronic processor, (e.g., a serial or parallel processor chip or specialized processor chip, a single- or multi-core chip, a microprocessor, a field programmable gate array, any variety of combinations of a control unit, arithmetic logic unit, and processor register, and so on), a computer (e.g., a processor operatively coupled to a memory), or another electronically operated controller to implement aspects detailed herein.

Accordingly, for example, examples of the technology may be implemented as a set of instructions, tangibly embodied on a non-transitory computer-readable media, such that a processor may implement the instructions based upon reading the instructions from the computer-readable media. Some examples of the technology may include (or utilize) a control device such as, e.g., an automation device, a special purpose or programmable computer including various computer hardware, software, firmware, and so on, consistent with the discussion herein. As specific examples, a control device may include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, may be executed in different orders than are expressly illustrated or described, as appropriate for particular examples of the technology. Further, in some examples, certain operations may be executed in parallel or partially in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer may be a component. A component (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that may be present in any variety of combinations, rather than an exclusive list of components that may be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “only one of,” or “exactly one of.”

In the description above and the claims below, the term “connected” may refer to a physical connection or a logical connection. A physical connection indicates that at least two devices or systems co-operate, communicate, or interact with each other, and are in direct physical or electrical contact with each other. For example, two devices are physically connected via an electrical cable. A logical connection indicates that at least two devices or systems co-operate, communicate, or interact with each other, but may or may not be in direct physical or electrical contact with each other. Throughout the description and claims, the term “coupled” may be used to show a logical connection that is not necessarily a physical connection. “Co-operation,” “the communication,” “interaction” and their variations include at least one of: (i) transmitting of information to a device or system; or (ii) receiving of information by a device or system.

Any mark, if referenced herein, may be common law or registered trademarks of third parties affiliated or unaffiliated with the applicant or the assignee. Use of these marks is by way of example and shall not be construed as descriptive or to limit the scope of disclosed or claimed embodiments to material associated only with such marks.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the application, ordinal numbers (e.g., first, second, third, etc.) may be used as an adjective for an element (i.e., any noun in the application). Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section.

The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application.

Unless otherwise indicated, like parts and method steps are referred to with like reference numerals.

Although the present technology has been described by referring to certain examples, workers skilled in the art will recognize that changes may be made in form and detail without departing from the scope of the discussion.

What is claimed is:

1. A mobile device comprising:
a transceiver configured to:
wirelessly receive a short-range signal;
a position sensor configured to:
wirelessly receive a navigation signal;
memory configured to:
store application settings comprising silent area information that identifies a geographic location where a silent area is established and quiet zone information that identifies a geographic location where a quiet zone is established; and
control circuitry configured to:
process, when the position sensor receives the navigation signal, the quiet zone information and the navigation signal to determine whether or not the mobile device is in the quiet zone, and
process, when the control circuitry determines that the mobile device is in a location other than the quiet zone, the silent area information and the short-range signal to determine whether or not the mobile device is in the silent area.

2. The mobile device according to claim 1, further comprising:
a speaker configured to emit audible sounds.

3. The mobile device according to claim 2, wherein the control circuitry is configured to:
inhibit, when the control circuitry determines that the mobile device is in the silent area, the speaker from emitting the audible sounds.

4. The mobile device according to claim 3, wherein the control circuitry is configured to:
permit, when the control circuitry determines that the mobile device is in the location other than the quiet zone, the speaker to emit the audible sounds.

5. The mobile device according to claim 3, wherein the control circuitry is configured to:
permit, when the control circuitry determines that the mobile device is in a location other than the silent area, the speaker to emit the audible sounds.

6. The mobile device according to claim 2, wherein the control circuitry is configured to:
inhibit, when the control circuitry determines that the mobile device is in the quiet zone, the speaker from emitting the audible sounds.

7. The mobile device according to claim 6, wherein the control circuitry is configured to:
permit, when the control circuitry determines that the mobile device is in a location other than the silent area, the speaker to emit the audible sounds.

8. The mobile device according to claim 6, wherein the control circuitry is configured to:
permit, when the control circuitry determines that the mobile device is in a location other than the quiet zone, the speaker to emit the audible sounds.

9. The mobile device according to claim 1, wherein the control circuitry is configured to:
compare, when processing the quiet zone information and the navigation signal, the quiet zone information with position information that identifies a geographic position of the mobile device.

10. The mobile device according to claim 9, wherein the control circuitry is configured to:
obtain, when the position sensor receives the navigation signal, the position information from the navigation signal.

11. The mobile device according to claim 9, wherein the control circuitry is configured to:
determine, when the quiet zone information comprises the position information, that the mobile device is in the quiet zone.

12. The mobile device according to claim 1, wherein the control circuitry is configured to:
compare, when processing the silent area information and the short-range signal, the silent area information with an identifier that uniquely identifies the short-range signal.

13. The mobile device according to claim 12, wherein the control circuitry is configured to:
extract, when the transceiver receives the short-range signal, the identifier from the short-range signal.

14. The mobile device according to claim 12, wherein the control circuitry is configured to:
determine, when the silent area information comprises the identifier, that the mobile device is in the silent area.

15. The mobile device according to claim 1, further comprising:
a graphic user interface to receive, manually from a user of the mobile device, the application settings.

16. A method comprising:
wirelessly receiving, by a transceiver, a short-range signal;
wirelessly receiving, by position sensor, a navigation signal;
storing, in memory, application settings that comprise:
silent area information that identifies a geographic location where a silent area is established, and
quiet zone information that identifies a geographic location where a quiet zone is established;
processing, by control circuitry when the position sensor receives the navigation signal, the quiet zone information and the navigation signal to determine whether the mobile device is in the quiet zone; and
processing, by the control circuitry when the control circuitry determines that the mobile device is in a location other than the quiet zone, the silent area information and the short-range signal to determine whether the mobile device is in the silent area.

17. The method according to claim 16, further comprising:
inhibiting, by the control circuitry when the control circuitry determines that the mobile device is in either the quiet zone or the silent area, a speaker from emitting audible sounds.

18. The method according to claim 17, further comprising:
permitting, by the control circuitry when the control circuitry determines that the mobile device is in the location other than the quiet zone, the speaker to emit the audible sounds.

19. A non-transitory computer-readable medium on which is stored instructions that when executed by a processor, cause the processor to:
control a transceiver to wirelessly receive a short-range signal;
control a position sensor to wirelessly receive a navigation signal;
control memory to store application settings that comprise silent area information that identifies a geographic location where a silent area is established and quiet zone information that identifies a geographic location where a quiet zone is established;
process, when the position sensor receives the navigation signal, the quiet zone information and the navigation signal to determine whether the mobile device is in the quiet zone; and
process, when the control circuitry determines that the mobile device is in a location other than the quiet zone, the silent area information and the short-range signal to determine whether the mobile device is in the silent area.

20. The non-transitory computer-readable medium according to claim 19 on which is stored instructions that when executed by a processor, further cause the processor to:
control, when the control circuitry determines that the mobile device is in either the quiet zone or the silent area, a speaker to inhibit audible sound emissions from the speaker.
